(19) United States
(12) Patent Application Publication
(10) Pub. No.: US 2026/0261998 A1
(43) Pub. Date: Sep. 3, 2026

(54) Systems and Methods for Group Association of Devices in Wireless Personal Area Networks

(71) Applicant: Mitsubishi Electric Research Laboratories, Inc., Cambridge, MA (US)

(72) Inventors: Jianlin Guo, Newton, MA (US); Pu Wang, Cambridge, MA (US); Kieran Parsons, Gloucester, MA (US); Petros Boufounos, Winchester (UA); Philip Orlik, Cambridge, MA (US)

(73) Assignee: Mitsubishi Electric Research Laboratories, Inc., Cambridge, MA (US)

(21) Appl. No.: 19/067,915

(22) Filed: Mar. 2, 2025

(51) Int. Cl. H04W 60/00; H04W 16/28; H04W 74/0816

(52) U.S. Cl. CPC H04W 60/005; H04W 16/28; H04W 74/0816

(57) ABSTRACT

A method for performing group-based association in a wireless communication network compliant with the IEEE 802.15.4 standard is provided. The method comprises receiving, by a network coordinator, association requests from a plurality of devices seeking to join the network. The method further comprises grouping the plurality of devices into one or more groups based on at least one grouping criterion selected from: (1) an association type indicating the priority of devices seeking association, (2) a time interval during which the association requests were received, (3) spatial proximity of the devices to the network coordinator, (4) a communication channel used by the devices, or (5) a beamforming direction relative to the network coordinator. The method further comprises transmitting, by the network coordinator, a group association response to each group, the association response including parameters required for devices within the group to complete the association process. The method further comprises announcing, by the network coordinator, a silent period for devices outside the active group during the transmission of the association response to reduce channel access contention and transmission collision. The method further comprises completing the association of the devices in each group with the network coordinator in a sequential or parallel manner.

### TECHNICAL FIELD

The present disclosure generally relates to wireless communication in personal area networks, and particularly to systems and methods for group association of devices in IEEE 802.15.4 personal area networks (PANs).

### BACKGROUND

Wireless communication has become integral to modern applications, enabling seamless connectivity between devices across various domains, including Internet of Things (IoT), smart homes, healthcare, and industrial automation. Among the technologies, IEEE 802.15.4 standard finds implementation in various consumer electronic devices, the well-known protocols such as Bluetooth, ZigBee and 6LoWPAN. The IEEE 802.15.4 standard is widely adopted for its low data rate, low cost, low power consumption, and short-range communication, making the standard ideal for forming Personal Area Networks (PANs). However, in dense networks, multiple devices may often detect the channel as clear simultaneously, leading to collisions when they attempt to transmit at the same time. The unicast association process creates a bottleneck, causing latency and delays when numerous devices attempt to join the network simultaneously. This inefficiency is particularly problematic in time-sensitive applications where even small delays can compromise operational efficiency and user experience. Existing methods include time division multiple access (TDMA) and priority-based channel access and adaptive backoff algorithms which are slow, complex and resource intensive to implement.

Accordingly, there is a need for efficient and robust systems and methods for effective and fast association mechanisms for IEEE 802.15.4 communication networks.

### SUMMARY

Various example embodiments are directed towards accelerating the association procedure in IEEE 802.15.4 wireless communication networks through group-based association methods. Although originally designed for non-time-critical applications in small-scale networks, the standard for IEEE 802.15.4 wireless communication networks has enhanced to support long-range communication in large-scale networks with a large number of devices. Additionally, due to several reasons IEEE 802.15.4 is the preferred choice in secure, time-critical applications, such as automatic door opening, which require faster association procedures. Some example embodiments are based on the understanding that it would be advantageous for such time critical applications to have an accelerated association process for the devices joining the network. To that end, some example embodiments provide a group association method to accelerate the association process and introduce grouping methods to efficiently organize devices for the network. The grouping methods include association type-based, distance-based, time-based, communication channel-based, and beamforming-based device grouping. In this way, various example embodiments improve the efficiency and scalability of device association, enabling faster and more reliable network access in large-scale and time-sensitive applications.

The IEEE 802.15.4 standard, widely used in personal area networks (PANs), was originally designed for small-scale, low-power, and low-cost applications. While effective for these scenarios, its limitations become apparent in modern, high-density, and time-critical networks. A key inefficiency lies in the use of Carrier Sense Multiple Access with Collision Avoidance (CSMA/CA) for channel access. This mechanism requires devices to sense the channel for activity before transmitting, ensuring it is clear. Some embodiments recognize that the inefficiency of conventional IEEE 802.15.4 networks arises from their inability to handle a large number of simultaneous association requests. In particular, the traditional sequential approach results in increased latency as more devices attempt to join the network. For example, in dense networks, multiple devices often detect the channel as clear simultaneously, leading to collisions when they attempt to transmit at the same time. These collisions trigger backoff delays, where devices wait for randomized periods before retransmitting, exponentially increasing response times and reducing network efficiency. In time-critical applications, such as secure door authentication, these delays can render the system impractical.

Additionally, the standard mechanism lacks an optimized grouping method to manage large-scale associations efficiently. Another inefficiency stems from the unicast communication model used during the association process. Each device attempting to join the network must send an association request to the PAN coordinator, which then processes and responds individually with a unicast association response. This one-on-one approach creates a bottleneck when many devices seek to join the network simultaneously. Each device's request-response cycle consumes valuable time, and the serialized handling of requests leads to significant delays. Furthermore, the contention access period (CAP) during which devices send their requests is prone to collisions, further compounding delays and making the system unsuitable for large-scale deployments. Consequently, there is a need for an approach that accelerates the association process while maintaining the network's reliability and performance.

To address these limitations, the protocol can be enhanced to enable group-based association, replacing the unicast response model with multicast or broadcast communication. In group association, devices are grouped based on shared characteristics such as request timing, spatial proximity, or communication channel. Instead of responding to each device individually, the coordinator sends a single multicast response to all devices in a group, simultaneously completing the association process for multiple devices. For instance, devices that send requests within a certain time window can be grouped together, or devices in different spatial sectors can be addressed using beamforming. This eliminates the need for one-on-one communication and reduces contention during CAP by allowing silent periods for devices outside the active group.

Various embodiments realize that grouping devices before initiating the association process significantly reduces latency and improves efficiency. Group association is inherently more efficient because it minimizes communication overhead and reduces the probability of collisions. By aggregating responses, the network processes multiple requests in parallel, lowering latency. For large-scale networks, this scalability advantage is critical, as it ensures that performance remains consistent even with a high density of devices. Some embodiments further recognize that different grouping criteria optimize network performance depending on the deployment scenario. For example, grouping devices by spatial proximity or communication channel distributes traffic evenly, preventing bottlenecks on a single channel or area. For time-critical applications, the faster and more predictable association times provide a smoother user experience, addressing the limitations of traditional methods. In effect, the shift from unicast to group-based association leverages multicast or broadcast communication to overcome the inefficiencies of the IEEE 802.15.4 standard. By addressing multiple devices simultaneously and reducing contention, group association makes the protocol scalable and suitable for modern applications, from IoT networks to real-time authentication systems. This innovative adaptation ensures that the protocol can meet the demands of high-density, time-sensitive scenarios while maintaining its original low-power and low-cost advantages.

Accordingly, various embodiments introduce distinct grouping methods to streamline the association process and manage large-scale device associations effectively. In this regard, some embodiments provide an association type-based grouping approach, where devices are grouped based on the association type carried in their association requests, where association type 1 represents the fast association request and association type 0 indicates the regular association request. The approach reduces association delays for time-critical devices. When multiple devices send association requests, the network coordinator organizes the requests into groups based on their association types with type 1 requests having higher priority than type 0 requests.

Some embodiments further provide a time-based grouping approach, where devices are grouped based on the time intervals during which their association requests are received. The approach reduces queuing delays and accelerates the processing of simultaneous requests. When multiple devices send association requests, the network coordinator organizes the requests into groups based on their arrival times.

Some embodiments further provide a proximity-based grouping approach, which organizes devices based on their spatial proximity to the network coordinator. In this approach, the network coordinator evaluates the physical distances of devices based on signal strength, location information, or estimated transmission delays. Devices located closer to one another or within a defined radius are grouped together, allowing the network coordinator to manage their association collectively.

Some embodiments further provide a communication channel-based grouping approach where devices using the same communication channel are grouped together. However, some embodiments realize that when many devices attempt to associate with the network simultaneously on different channels, the network coordinator may face channel contention and increased overhead in managing separate responses. By grouping devices that share the same communication channel, the network coordinator can efficiently manage channel resources and handle multiple associations within a single group response.

Some embodiments further provide a beamforming-based grouping approach where devices are grouped based on the directionality of communication beams relative to the network coordinator. In this method, the network coordinator uses beamforming a signal processing technique that directs communication signals in specific directions rather than broadcasting them in all directions. Devices that fall within the same directional beam or spatial sector are grouped together for simultaneous association.

Accordingly, one embodiment discloses a computer-implemented method for group association for IEEE 802.15.4 networks. The method comprises receiving by a network coordinator, association requests from a plurality of devices seeking to join the network. The method further comprises grouping the plurality of devices into one or more groups based on at least one grouping criterion selected from: (1) association type requested by the devices, (2) a time interval during which the association requests were received, (3) spatial proximity of the devices to the network coordinator, (4) a communication channel used by the devices, or (5) a beamforming direction relative to the network coordinator. The method further comprises transmitting, by the network coordinator, a group association response to each group. The association response includes parameters required for devices within the group to complete the association process. The method further comprises announcing, by the network coordinator, a silent period for devices outside the active group during the transmission of the association response to reduce channel access contention and transmission collision. The method further comprises completing the association of the devices in each group with the network coordinator in a sequential or parallel manner.

In yet another embodiment, a computer system for group association for IEEE 802.15.4 networks is provided. The system comprises a memory configured to store instructions and a processor configured to execute the instructions to receive association requests from a plurality of devices seeking to join the network and group the plurality of devices into one or more groups based on at least one grouping criterion selected from: (1) association type requested by the devices, (2) a time interval during which the association requests were received, (3) spatial proximity of the devices to the network coordinator, (4) a communication channel used by the devices, or (5) a beamforming direction relative to the network coordinator. The processor is further configured to control a network coordinator device to transmit a group association response to each group. The association response includes parameters required for devices within the group to complete the association process. The processor is further configured to announce a silent period for devices outside the active group during the transmission of the association response to reduce channel access contention and transmission collision. The processor is further configured to complete the association of the devices in each group with the network coordinator in a sequential or parallel manner.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1 illustrates a block diagram of a system for group association for IEEE 802.15.4 networks, according to some embodiments;

FIG. 2 illustrates a flowchart of a method for systems and methods for group association for IEEE 802.15.4 networks, according to some embodiments;

FIG. 3A is a diagram that illustrates association request acquisition of flowchart of FIG. 2, according to some embodiments;

FIG. 3B is a diagram that illustrates grouping of association of flowchart of FIG. 2 according to some embodiments;

FIG. 3C is a diagram that illustrates assigning a silent period of flowchart of FIG. 2, according to some embodiments;

FIG. 4A is a diagram illustrating a superframe structure for IEEE 802.15.4 networks, according to some embodiments;

FIG. 4B shows a general MAC frame format for IEEE 802.15.4 networks, according to some embodiments;

FIG. 4C shows a MAC command frame format, wherein MAC association request and response frames are command frames for IEEE 802.15.4 networks, according to some embodiments;

FIG. 4D shows a frame control field format of IEEE 802.15.4 networks, according to some embodiments;

FIG. 5 shows a PAN ID compression field values for IEEE 802.15.4 networks, according to some embodiments;

FIG. 6A demonstrates the content field of IEEE 802.15.4 networks MAC association request command, according to some embodiments;

FIG. 6B shows capability information field format of the content field in IEEE 802.15.4 MAC association request command, according to some embodiments;

FIG. 7A demonstrates the content field of IEEE 802.15.4 MAC association response command, according to some embodiments;

FIG. 7B shows valid values of association status field in the content field of IEEE 802.15.4 MAC association response command, according to some embodiments;

FIG. 8A demonstrates the group content field for IEEE 802.15.4 MAC association response command with group response capability, according to some embodiments;

FIG. 8B shows the format of association response in the group content field for IEEE 802.15.4 MAC association response command with group response capability, according to some embodiments;

FIG. 9A shows association type-based device grouping method for group association in IEEE 802.15.4 standard, according to some embodiments;

FIG. 9B shows time-based device grouping method for group association in IEEE 802.15.4 standard, according to some embodiments;

FIG. 9C illustrates distance-based device grouping method for group association in IEEE 802.15.4 standard, according to some embodiments;

FIG. 9D illustrates communication channel-based device grouping method for group association in IEEE 802.15.4 standard, according to some embodiments;

FIG. 9E depicts beamforming-based device grouping method for group association in IEEE 802.15.4 standard, according to some embodiments;

FIG. 10 depicts a flow diagram illustrating a use case for group association for IEEE 802.15.4 networks, according to some embodiments; and

FIG. 11 illustrates some components of a system for group association for IEEE 802.15.4 networks, according to some embodiments.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like-reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

### Overview

There are many application scenarios of IEEE 802.15.4 networks that require fast association, i.e., fast network joining, to improve user experience, e.g., hand-free secure door opening. In such scenarios, long association delays are not acceptable. The embodiments of current disclosure provide systems and methods to reduce device association latency in personal area networks (PANs) via group association mechanism.

The IEEE 802.15.4 standard, a cornerstone for personal area networks (PANs), was originally designed for small-scale, low-power, and low-cost applications. However, its limitations emerge in modern high-density and time-critical networks, such as secure door authentication systems. Some embodiments recognize that these inefficiencies stem from the use of Carrier Sense Multiple Access with Collision Avoidance (CSMA/CA) for channel access. In dense networks, multiple devices often detect a clear channel simultaneously, resulting in collisions during transmission attempts. These collisions cause backoff delays, increasing response times and undermining network efficiency issues that are particularly problematic in time-sensitive applications.

Additionally, some embodiments realize that the unicast communication model used during the association process creates a bottleneck in large-scale deployments. Under the conventional IEEE 802.15.4 protocol, each device sends an individual association request, and the PAN coordinator responds with a separate unicast reply. When many devices attempt to join network simultaneously, this serialized approach results in significant delays due to increased contention and collisions during the contention access period (CAP), limiting scalability and efficiency.

To address these challenges, some embodiments realize a group-based association method that leverages multicast or broadcast communication to replace traditional one-on-one responses. Devices are grouped based on shared attributes, such as association type, request timing, spatial proximity, or communication channel. Rather than responding individually, the PAN coordinator issues a single multicast association response to all devices in a group. For example, devices that send requests within a defined time window or those grouped through beamforming techniques may be associated simultaneously. Additionally, the introduction of silent periods prevents devices outside the active group from transmitting, reducing contention and collisions during the CAP.

Various embodiments have several practical applications across diverse industries, including smart home automation, industrial IoT, intelligent transportation systems, emergency response networks, and large-scale sensor deployments. The practical applications are driven by the ability to replace inefficient, unicast-based association methods with a group-based approach, making the system faster, reduce the probability of frame collision, reduce association latency and using distance and time-based grouping methods, the earlier coming devices get associated earlier

### System and Method for Group Association

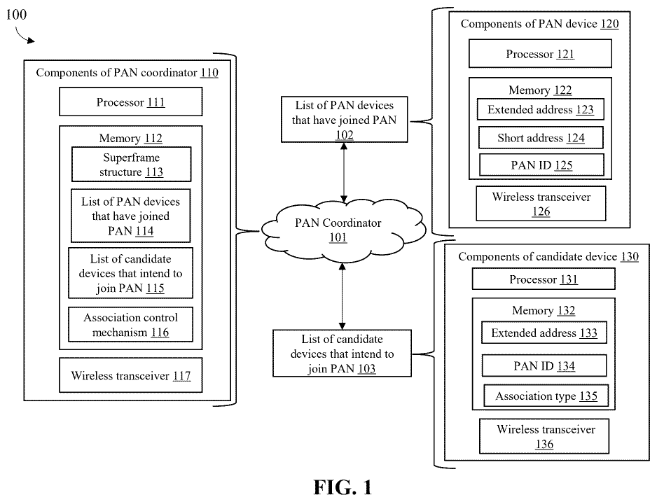

FIG. 1 illustrates a block diagram of an IEEE 802.15.4 system 100 for group association, according to some embodiments. The system 100 consists of a PAN Coordinator 101, a list of the PAN devices 102 that have already joined PAN and a list of the candidate devices 103 that intend to join PAN, where PAN coordinator 101 is equipped with components 110, a PAN device 102 is equipped with components 120, and a candidate device 103 is equipped with components 130.The PAN coordinator components 110 include a processor 111, a memory 112 and a wireless transceiver 117. The memory module 112 stores the data hosting specialized modules that drive the intelligence of the system 100.

The memory 112 may store instructions that are executable by the PAN coordinator 101 and any data that may be utilized by the methods and systems of the present disclosure. The memory 112 may include random access memory (RAM), read only memory (ROM), flash memory, or any other suitable memory systems. The memory 112 may be a volatile memory unit or units, and/or a non-volatile memory unit or units. The memory 112 may also be another form of computer-readable medium, such as a magnetic or optical disk.

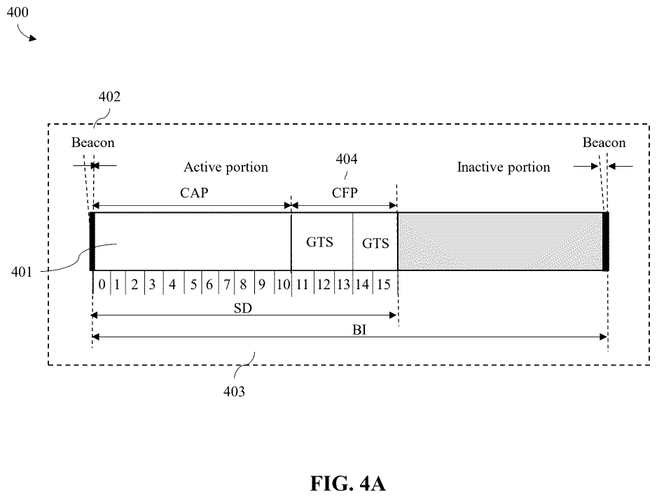

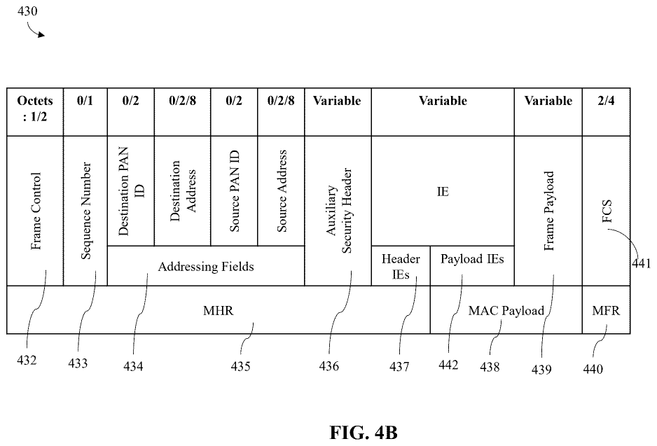

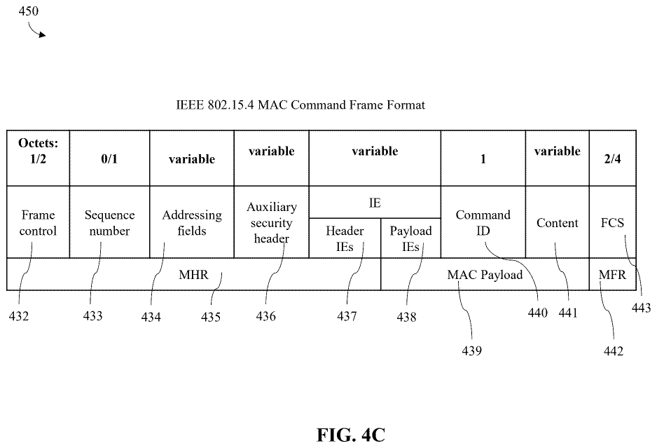

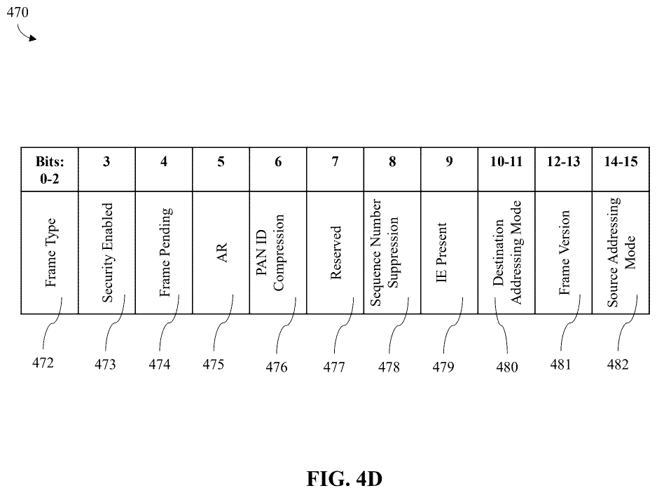

The memory 112 further stores a superframe structure 113, list of PAN devices that have joined PAN 114, list of candidate devices that intend to join PAN 115 and an association control mechanism 116. The superframe structure 113 defines the time division of the communication channel, allowing devices to communicate in an organized manner. The superframe structure 113 is structured into two primary periods: the active period and the inactive period. The active period contains the contention access period (CAP) and optional guaranteed time slots (GTS), while the inactive period is used for energy-saving. The superframe 113 is crucial in IEEE 802.15.4 for coordinating device communication, ensuring that devices transmit in a synchronized manner, reducing potential collisions. The structure of superframe 113 is further explained in the description of FIG. 4A.

The list of PAN devices that have joined PAN 114 stores information of PAN devices 102 that are currently part of the Personal Area Network (PAN). The stored information includes device's extended address, allocated short address, device capability, etc. The PAN devices have successfully gone through the association procedure and are active members of the network. The list is updated each time a new device successfully joins, and helps the system 100 track and manage the devices that communicate over the network. For example, the candidate devices 103 appear on the list after their successful association with the PAN coordinator 101. The system 100 uses the stored lists to make sure that communications are properly routed to existing devices and to handle any updates to the network topology.

The list of candidate devices that intend to join PAN 115 stores information of candidate devices 103 that have expressed a desire to join the PAN but have not yet completed the association process. The stored information includes device's extended address, association type, device capability, etc. The devices may be in different stages of the association procedure, such as preparing an association request to PAN coordinator 101 or waiting for an association response from the PAN coordinator 101. The reasons for a device intending to join the network may vary: for instance, new devices such as mobile sensors or wearables (such as key tags in a secure door authentication system) may want to join to request services such as data access or trigger specific actions such as door opening. Devices on the list may include IoT devices or remote sensors attempting to integrate into the network for data transmission or control. The association control mechanism 116 is responsible for managing the entire association process. The association control mechanism 116 handles tasks of receiving and processing association requests, grouping devices based on criteria such as time or proximity, and coordinating the transmission of association responses. The association control mechanism 116 ensures that the network operates efficiently by controlling when and how devices are allowed to join. The association control mechanism 116 reduces network congestion and minimizes communication delays by valid and synchronized requests.

Processor 111, a key component of the PAN coordinator 101 for group association in IEEE 802.15.4 networks, is responsible for executing instructions and performing computational tasks to the network's operation. The processor 111 processes data received from various PAN devices 102, and candidate devices 103. This processing involves interpreting association requests, applying grouping criteria, and coordinating communication with the PAN devices. The processor 111 executes the network protocols defined by IEEE 802.15.4, for efficient device association, communication, and disassociation. The processor 111 manages the grouping process by analyzing the association type of requests, time interval of requests, spatial proximity of devices, communication channels, and beamforming directions to form logical device groups. Additionally, the processor 111 oversees the silent period management, ensuring devices not currently involved in the association process remain inactive to avoid contention. Beyond the core group association tasks, the processor 111 dynamically updates the lists of PAN devices that have joined PAN 114 and candidate devices that intend to join PAN 115. The processor 111 also interacts with the association control mechanism 116 to enforce policy rules, prioritize device requests, and optimize resource allocation.

Wireless transceiver 117 serves as the communication interface for PAN coordinator 101, enabling data transmission and reception between the PAN coordinator 101, PAN devices 102, and candidate devices 103 in the IEEE 802.15.4 network. The wireless transceiver 117 operates in accordance with the IEEE 802.15.4 standard, facilitating low-power, short-range wireless communication while maintaining reliable network performance. The wireless transceiver 117 performs functions such as transmitting beacon frames, receiving association requests, and sending group association responses to devices seeking to join the PAN. The wireless transceiver 117 may support multi-channel communication, allowing the PAN coordinator 101 to communicate with multiple device groups either sequentially or in parallel, depending on the network traffic and grouping criteria. Additionally, the wireless transceiver 117 may assist with beamforming by focusing signals toward specific spatial sectors. The beamforming capability improves signal strength, extends communication range, and enhances overall network efficiency by minimizing interference from devices outside the target sector. The wireless transceiver 117 plays a role in silent period enforcement. During the silent period, the wireless transceiver 117 broadcasts control messages instructing non-participating devices to temporarily suspend their transmission attempts, reducing contention and collision during the group association process. Furthermore, the wireless transceiver 117 implements adaptive transmission power control to optimize energy consumption, particularly for battery-powered devices within the PAN. The wireless transceiver 117 ensures secure communication by integrating with the association control mechanism 116 to authenticate devices before granting access to the network.

The PAN coordinator 101 allows the system's components, such as processor 111, memory 112 and PAN devices 102, to communicate effectively over a wireless or wired network. The PAN coordinator 101 serves as the central management entity in an IEEE 802.15.4-based personal area network (PAN), overseeing device association, communication scheduling, and network maintenance. While the PAN coordinator 101 primarily operates wirelessly, and may also interface with wired communication infrastructure when network architecture or application requirements necessitate. In wired configurations, the PAN coordinator 101 may use Ethernet or serial connections, such as RS-485, to integrate with external control systems. This approach is common in real world applications such as industrial automation or building management environments where reliability and minimal wireless interference are required. The wired connection is typically used for backhaul communication, connecting the PAN coordinator 101 to broader network infrastructures such as SCADA systems or cloud platforms. Conversely, wireless networks, including Wi-Fi, 5G, Zigbee, LoRaWAN, and satellite communication, provide flexibility and scalability for mobile or remote operations. The PAN coordinator 101 may include hardware components such as modems, Wi-Fi transceivers, or other communication devices responsible for establishing a connection to the wider network, enabling data transmission. Software within the PAN coordinator 101 may be responsible for packetizing and de-packetizing data for network communication or managing communications over a cloud-based platform. In some embodiments, the PAN coordinator 101 combines control and forwarding functions on the same physical hardware, while in other cases, the functions may be split, with the control functions managed by external network devices in configurations such as software-defined networking (SDN).

A PAN device 102 is a networked device which participates in the IEEE 802.15.4 PAN by communicating with the PAN coordinator 101 and various available devices within the network. The PAN device 102 may serve various roles depending on the application, such as a sensor, actuator, or control device. The PAN device 102 comprises processor 121, memory 122, and wireless transceiver 126. The processor 121 is the core computational unit of the PAN device 102, responsible for executing network protocols, processing incoming and outgoing data, and managing device-specific tasks. The processor 121 runs software implementations of IEEE 802.15.4 MAC and PHY layers, which regulate how the device accesses the communication channel, manages collisions, and ensures reliable data transfer. The processor 121 also supports encryption algorithms, such as AES-128, to secure communications within the PAN. In certain applications, the processor 121 may run a real-time operating system (RTOS) to prioritize time-sensitive operations, such as environmental monitoring or industrial automation.

The memory 122 stores both operational data and persistent network parameters. The memory 122 typically includes a volatile memory, such as RAM, for temporary data during active communication and non-volatile memory, such as flash storage, to retain network configurations even when the device is powered off. The memory 122 stores an extended address 123, which is a globally unique 64-bit identifier assigned during the manufacturing process. The extended address 123 is fundamental for device authentication and addressing within the network, ensuring that devices may be uniquely recognized across different PANs. The extended address 123 is primarily used during the initial association phase, helping the PAN coordinator 101 distinguish between devices attempting to join. The memory 122 further stores a short address 124, which is a 16-bit address dynamically assigned by the PAN coordinator 101 when the device successfully associates with the network. The short address 124 reduces overhead in communication since it is efficient than using the 64-bit extended address for routine transmissions. For example, the PAN device 102 may initially communicate using its extended address 123 but may subsequently use its short address 124 to minimize packet size and improve energy efficiency. Additionally, the memory122 stores the PAN ID 125, which identifies the network to which the device belongs. The PAN ID 125 ensures the devices correctly distinguish between multiple co-located networks, a required feature in environments such as smart buildings or industrial facilities where multiple IEEE 802.15.4 networks may operate in close proximity.

The wireless transceiver 126 enables the PAN device 102 to communicate wirelessly with the PAN coordinator 101 and various devices. The wireless coordinator 126 supports frequency bands specified by IEEE 802.15.4, such as 2.4 GHz or sub-GHz options (e.g., 868 MHz in Europe or 915 MHz in the US) depending on the application requirements. The wireless transceiver 126 handles the physical layer operations, including modulation, demodulation, and signal strength measurements. In more advanced implementations, the wireless transceiver 126 may support beamforming to optimize communication in specific directions or dynamic channel selection to mitigate interference.

A candidate device 103 shares a similar structure and functionality as the PAN device 102 but is not allowed to access network since it is not yet a network member. For instance, while the PAN device 102 may have a short address 124, the candidate device 103 does not have a short address. Like its counterpart, the candidate device 103 includes a processor 131, which executes communication protocols and application-specific tasks. The processor 131 processes received commands (e.g., beacon and association from the PAN coordinator 101) and manages outgoing command transmissions (e.g., association request to the PAN coordinator 101). The candidate device 103 further includes a memory 132 which stores operational information, including its extended address 133, PAN ID 134 and association type 135 to be carried in association request. The wireless transceiver 136 facilitates wireless connectivity, which provides reliable data exchange within the PAN.

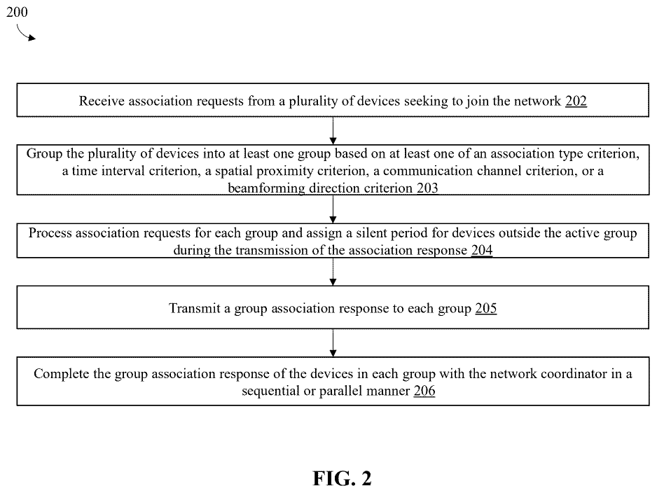

FIG. 2 illustrates a flowchart of a method 200 for systems and methods for group association for IEEE 802.15.4 networks, according to some embodiments. FIG. 2 is described with reference to one or more elements from FIG. 1. At step 202, the method 200 begins with receiving by a network coordinator, association requests from a plurality of devices seeking to join the network. The devices may include various IoT devices, such as sensors, smart meters, or other wireless communication devices, each transmitting an association request to join the network. The association requests may include information such as device identifiers, association type with 1 indicating fast association request and 0 indicating regular association request, requested network parameters, and priority indicators for time-sensitive applications.

At step 203, the network coordinator groups the plurality of devices into at least one group based on one or more grouping criteria. The criteria include an association type criterion, a time interval criterion, a spatial proximity criterion, a communication channel criterion, or a beamforming direction criterion. The association type criterion groups devices based on association types requested with type 1 requests processed earlier than type 0 requests. The time interval criterion groups devices based on times of their association request receptions with earlier requests processed earlier than later requests, thus minimizing the association delay. For example, if 10 devices send association requests within the same time window, the devices may be grouped together for efficient processing. The spatial proximity criterion groups devices based on their (devices) distance to the network coordinator 101 or their relative proximity to each other, which may be determined using signal strength or time-of-flight measurements. Devices which are close to the network coordinator 101 may be processed together, optimizing communication performance by reducing interference. For example, a device in a building close to the PAN coordinator 101 may be grouped with other nearby devices, optimizing communication by reducing signal interference. The communication channel criterion groups devices that are operating on the same channel, which helps the PAN coordinator 101 handle devices efficiently by avoiding interference from devices on different channels. The communication channel grouping may be beneficial when multiple communication channels are available, as the communication channel grouping helps manage resources effectively. For example, devices operating on channel 11 may be processed together, while devices on channel 15 may be grouped separately. The beamforming direction criterion groups devices that are in the same beamforming direction relative to the network coordinator, optimizing the network's ability to transmit and receive signals from devices located in similar spatial sectors, thus reducing interference from devices located in different directions. For instance, if the network coordinator uses beamforming to direct its signal in different spatial sectors, devices that are located in the same direction (say, north) may be grouped together.

At step 204, the network coordinator processes association requests for each group and assigns a silent period for devices outside the active group during the transmission of the association response. The silent period is to minimize channel access contention and prevent transmission collisions. For instance, if the network coordinator is sending the group association response to a group of devices located within a specific area or based on certain criteria, the network coordinator instructs devices outside the active group to refrain from transmitting association requests during this time. By assigning silent period helps the association response for the active group to be transmitted without interference from various devices attempting to access the network. For example, consider a scenario where there are 50 devices seeking association requests with the network or PAN coordinator, but only 10 devices are grouped into an active group based on proximity to the PAN coordinator. The PAN coordinator may assign a 2-second silent period during which the 40 other devices that are not part of the active group to hold off from transmitting any association requests which means the 10 devices in the active group successfully receive their association responses without the risk of collisions from other devices, which delay the process.

At step 205, the network coordinator transmits a group association response to each group. The group association response includes the parameters for devices within the group to complete the association process, such as association status, silent period, network-specific configuration details, device identifiers, or association control parameters. The transmitter ensures that all devices in the group are aligned with the network's settings and ready to proceed with the full association procedure.

At step 206, the network coordinator completes the group association response for the devices in each group either sequentially or in parallel. In the sequential approach, the network coordinator processes each group one by one, ensuring that devices are associated in a controlled manner, allowing for optimal use of available resources. In the parallel approach, multiple groups are processed simultaneously, which may significantly speed up the overall association process, especially when large numbers of devices are attempting to join the network. This flexibility ensures that the network coordinator may adapt to varying device densities and network conditions to maintain efficiency.

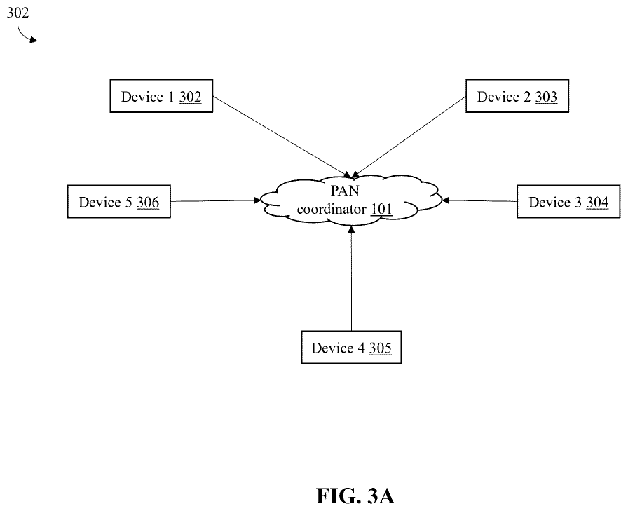

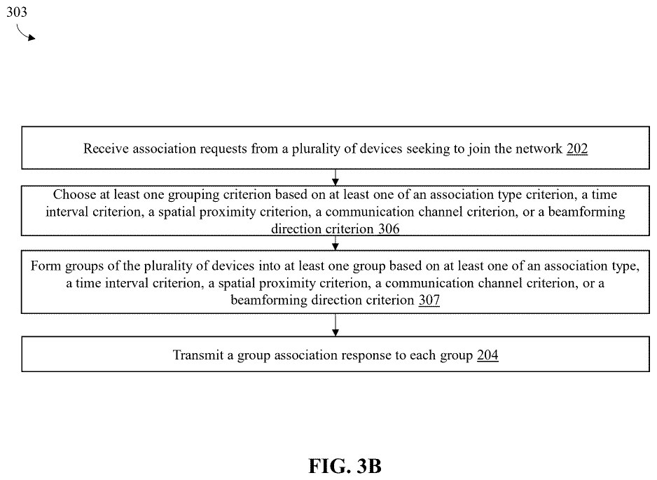

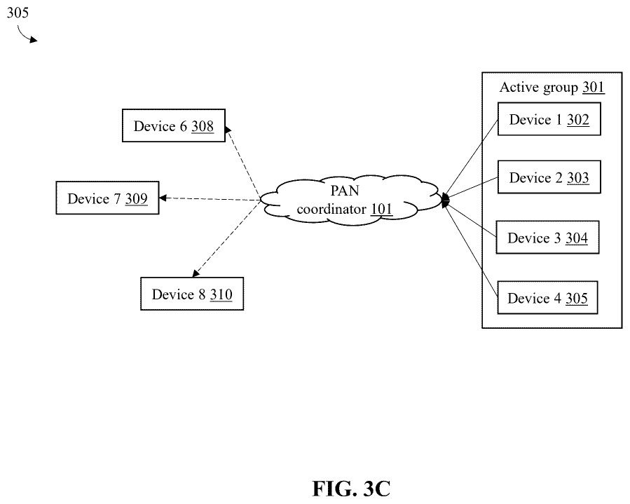

FIG. 3A is a diagram that illustrates association request acquisition 202 of flowchart of FIG. 2, according to some embodiments. FIG. 3A is described with reference to one or more elements from FIG. 1. The association request acquisition 202 includes multiple devices, and a PAN coordinator 101 where the PAN coordinator 101 receives association requests from multiple devices which are attempting to join the network. In the association request acquisition process 202, multiple devices, include device 1 302, device 2 303, device 3 304, device 4 305, and device 5 306, initiate the process of joining the network, by sending an association request to the PAN coordinator 101. Each device of multiple devices transmits its association request, which contains details such as device's address, association type, capabilities, and various network-related information which allows the PAN coordinator 101 to evaluate the request.

The PAN coordinator 101, represented as the central entity, receives the association requests from the multiple devices. The association requests are depicted as arrows pointing from each device of multiple devices towards the PAN coordinator 101. The PAN coordinator 101 is responsible for processing each incoming association request to determine whether the requesting device be successfully integrated into the network. The PAN coordinator 101 may use certain criteria, such as device capabilities or available resources, to make its decision. The association requests from multiple devices may arrive simultaneously or sequentially, depending on network conditions and the timing of each device's attempt to join. The received association requests are sent for subsequent actions in the association process, where the multiple devices are grouped and their requests are handled according to various grouping criteria to optimize the association process and reduce contention.

FIG. 3B is a diagram that illustrates grouping of association process 203 of flowchart of FIG. 2, according to some embodiments. FIG. 3B is described with reference to one or more elements from FIG. 1. At step 202, the process begins with receiving, by a network coordinator, association requests from a plurality of devices seeking to join the network. The devices may include various IoT devices, such as sensors, smart meters, or other wireless communication devices, each transmitting an association request to join the network. The association requests may include information such as device identifiers, association type, requested network parameters, and priority indicators for time-sensitive applications.

At step 306 the network coordinator chooses at least one grouping criterion based on at least one of an association type criterion, a time interval criterion, a spatial proximity criterion, a communication channel criterion, or a beamforming direction criterion. The association type criterion groups devices based on association types requested with type 1 requests processed earlier than type 0 requests. The time interval criterion groups devices based on times of their association request receptions with earlier requests processed earlier than later requests, thus minimizing the association delay The spatial proximity criterion groups devices based on their distance from the network coordinator or from each other, often determined through signal strength or time-of-flight measurements, with requests of devices closer to the PAN coordinator 101 processed earlier than that of devices away from the PAN coordinator 101. The communication channel criterion classifies devices operating on the same communication channel, to optimize resources by reducing cross-channel interference. The requests on different communication channels can be processed sequentially or in parallel. The beamforming direction criterion groups devices based on their relative direction from the network coordinator, typically by dividing the coverage area into sectors and grouping devices within the same sector. The requests from different sectors can be processed sequentially or in parallel.

At step 307 form groups of the plurality of devices into at least one group based on at least one of an association type criterion, a time interval criterion, a spatial proximity criterion, a communication channel criterion, or a beamforming direction criterion. Devices sharing the same chosen criterion are grouped together for efficient processing. The PAN coordinator applies the selected grouping criterion to organize devices into distinct groups. The grouping strategy provides streamline to the association process, reduce contention for communication resources, and optimize network performance. For instance, if the time interval criterion is selected, devices which send the association requests within the same predefined time window are grouped together. The approach ensures devices attempting to join the network within same time window are processed together, which reduces the overhead associated with handling individual requests and minimizes potential collisions. For example, if the PAN coordinator receives requests from 20 devices within a 100-millisecond window, the devices may be treated as a single group, allowing the PAN coordinator to respond efficiently.

Alternatively, if the spatial proximity criterion is chosen, devices located near each other are grouped together. The proximity may be determined using signal strength, time-of-flight measurements, or other localization techniques. Grouping devices based on the spatial location optimizes communication performance by reducing signal interference and makes use of network resources. For instance, devices in the same room or building may be grouped together, while devices in different areas are placed in separate groups. The spatial proximity criterion is useful in large-scale networks with geographically distributed devices, as the large-scale networks enable efficient and seamless communication by leveraging the physical layout of the network.

FIG. 3C is a diagram that illustrates assigning a silent period of flowchart of FIG. 2, according to some embodiments. FIG. 3C is described with reference to one or more elements from FIG. 1. FIG. 3C shows a PAN coordinator 101 managing communication with multiple devices by organizing multiple devices into an active group while assigning a silent period to other devices. The PAN coordinator 101, is the center of the network and communicates directly with an active group 301. The active group 301 includes four devices device 1 302, device 2 303, device 3 304, and device 4 305. These devices are actively engaged in communication during the association process.

Out of the active group 301, three devices are depicted device 6 308, device 7 309, and device 8 310. The three devices are assigned a silent period during the communication between the PAN coordinator 101 and the active group 301 devices. The silent period represents the devices (device 6, device 7, device 8) inactive status during the phase of response, ensuring the communication occurs without interference from external transmissions. The silent period is applied based on the grouping strategy outlined in the flowchart of FIG. 2. During the silent period, devices not part of the active group refrain from transmitting any association requests, which minimizes channel contention and enhances the reliability of the communication process for the active devices.

For example, consider a smart home security system using multiple devices to monitor and secure the property. In the home security system, the PAN coordinator functions as a central security hub, similar to a smart lock controller that manages communication between different/multiple devices. The active group may represent the primary devices actively involved in monitoring and responding to events such as door sensors, motion detectors, surveillance cameras, and glass-break sensors. Consider auxiliary devices, such as smart thermostats, lighting controllers, or additional sensors in inactive rooms. When the smart lock controller needs to process an access request for instance, verifying a family member's fingerprint or PIN, the PAN coordinator assigns a silent period to the auxiliary devices. The silent period is a period of temporarily pausing notifications from the thermostat or the lighting system so the controller focuses entirely on authenticating the lock request.

FIG. 4A is a diagram illustrating a superframe structure 400 for IEEE 802.15.4 networks, according to some embodiments. The illustrated superframe structure 400 is for a beacon-enabled PAN, which operates based on a time division that splits the communication interval into active and inactive periods. The superframe structure 400 includes a beacon slot 402, a contention access period (CAP) 401 and an optional contention free period (CFP) 404. Together, the beacon slot 402, CAP 401, and optional CFP 404 form the active portion of the beacon interval (BI) 403, which represents the total time duration between two consecutive beacon frames transmitted by the PAN coordinator 101.

During the active period of the superframe 400, devices in the PAN communicate based on two primary methods the carrier sense multiple access/collision avoidance (CSMA/CA) method in the CAP 401 and the guaranteed time slot (GTS) mechanism in the CFP 404. The CSMA/CA mechanism is a contention-based method where devices listen for a clear channel before transmitting, helping avoid collisions. In contrast, the GTS provides a contention-free mechanism for devices that need guaranteed access to the channel, typically for applications required for higher reliability or consistent data transfer. The inactive period in the superframe provides an opportunity for devices to enter sleep mode or conserve energy, which is for low-power devices like sensors in the Internet of Things (IoT) networks.

The beacon interval (BI), defined as the time between two consecutive beacon frames, serves as the overall cycle time for the superframe. The beacons, sent periodically by the PAN coordinator 101, provide synchronization information and allow devices to join or leave the network. The superframe duration (SD) refers to the total active time of one complete superframe, which encompasses both the active and inactive periods. The exact duration of the superframe can be adjusted to meet the needs of the network, depending on the number of devices, the communication frequency, and the power requirements. Shorter superframes result in frequent beacon transmissions, improving network responsiveness but increasing energy consumption. Longer superframes offer reduced energy use but result in higher latency.

To join a beacon-enabled network, devices go through an association mechanism defined by the IEEE 802.15.4 standard. This mechanism facilitates devices to request joining the PAN by sending an association request frame to the PAN coordinator 101, which responds with an association response frame. The request and response process ensures the devices are properly integrated into the network. The association request frame sent by the device includes information, such as the device's address, association type and device capabilities. Upon receiving the request, the PAN coordinator 101 processes the information and sends back an association response frame, which indicates whether the device's request is accepted or denied. The response frame may also contain additional data such as the assigned short address for the device and other network parameters. If the device wishes to leave the network, the device sends a disassociation request frame, signaling to the PAN coordinator 101 that it no longer requires network resources.

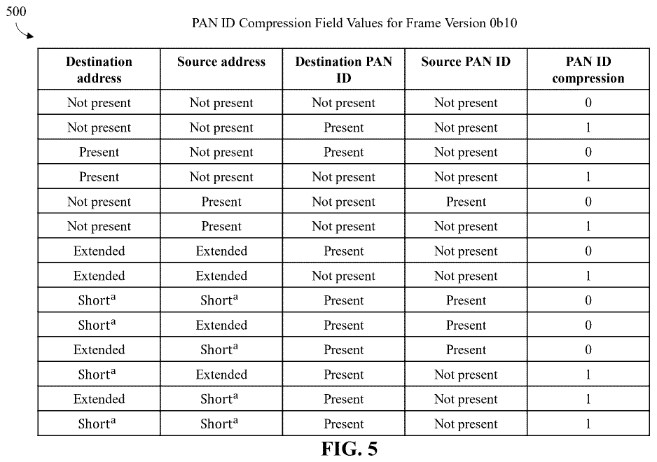

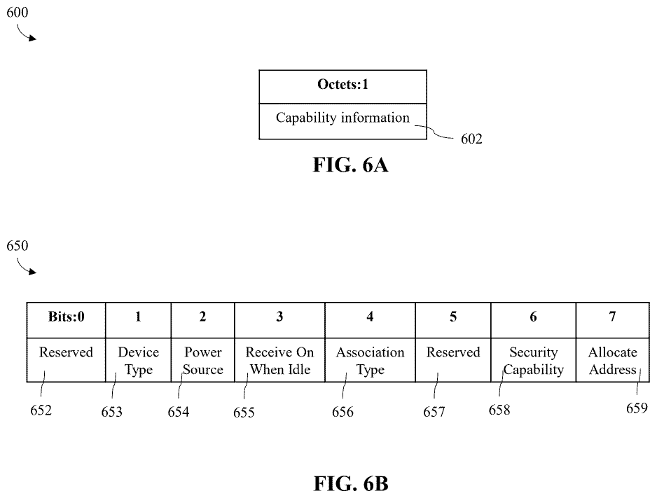

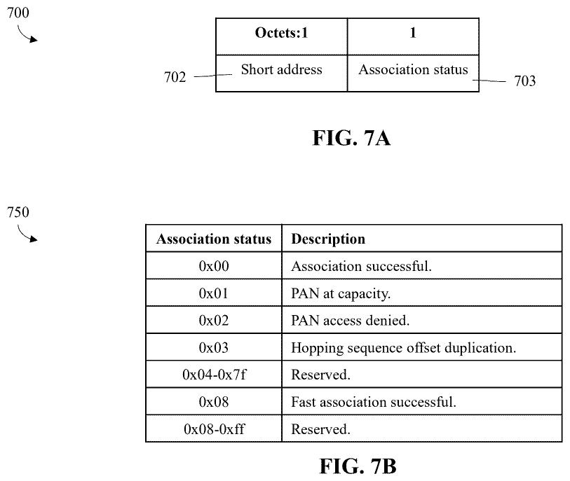

The messages are carried within three key MAC command frames as specified by the IEEE 802.15.4 standard 1) MAC association request command frame, 2) MAC association response command frame and 3) MAC disassociation request command frame. MAC association request command frame, is transmitted by the device to request joining the PAN. (explained briefly in FIG. 6B). After receiving the association request, the PAN coordinator 101 evaluates the device's request and sends back an association response frame. (The association response frame is explained briefly in FIG. 7A). MAC disassociation request command frame is a frame when a device wishes to leave the PAN, the PAN sends a disassociation request frame to the PAN coordinator 101. The disassociation request frame informs the PAN coordinator 101 that the device does not needs to be part of the network, allowing the PAN coordinator 101 to free up resources associated with the device. Upon processing the disassociation request, the PAN coordinator 101 may remove the device from its list of active devices and may optionally perform any cleanup operations.

FIG. 4B shows a general MAC frame format 430 for IEEE 802.15.4 networks, according to some embodiments. The general MAC frame format 430 of the IEEE 802.15.4 standard, includes three main components the MAC header (MHR) 435, MAC Payload 438, and MAC Footer (MFR) 440. The MAC Header 435 is the first portion of the frame and contains information for processing and managing the frame. The MAC header 435 includes a frame control field 432, a sequence number 433, addressing fields 434, an auxiliary security header (ASH) 436, header information elements (IEs) 437. The frame control field (FC) 432 typically of 1 or 2 octets (8 or 16 bits) long and contains various flags describing the frame type, security settings, addressing modes, and various control information. The frame control field 432 is used to identify whether the frame is an association request, data frame, acknowledgment, or another type of frame. The FC field 434 also helps determine whether the frame uses security, among other control operations. The FC field 432 is often used by the receiver to detect missed frames and help reassemble a complete message. Sequence number (SN) 433 is a field, which may be either 0 or 1 octet, helps in identifying and sequencing frames. Sequence numbers 433 are useful for keeping track of the order of frames in a communication session and ensuring no frames are lost or duplicated.

Addressing Fields 434 are the fields which define the source and destination addresses for the frame. The addressing fields 434 are variable in size (from 0 to 8 octets) and may include destination PAN ID, destination address, source PAN ID and source address. destination PAN ID is a field which indicates the PAN (personal area network) to which the frame is directed. It may be 0, 2, or 8 octets long depending on the addressing mode. Destination address includes address of the destination device. The field may be 0, 2, or 8 octets long, depending on whether the frame uses short or extended addressing. Source PAN ID is a field which indicates the PAN from which the frame originates. The source PAN ID, may be 0, 2, or 8 octets. Source address is the address of the source device sending the frame. Source address may be 0, 2, or 8 octets, depending on the addressing mode used (short or extended).

Auxiliary security header (ASH) 436 is an optional field and is included if security is applied to the frame. ASH 436 provides data to facilitate the secure transmission of the frame, such as cryptographic keys or information to authenticate the message. Header information elements (IEs) 437 are variable-length fields used to include additional metadata or information relevant to the frame. Header information elements (IEs) may carry information such as the network's capabilities, operational parameters, or specific settings related to the physical layer (PHY), security attributes, or other management information.

The MAC payload 438 contains the actual data being transmitted. The MAC payload 438 is a part of the general MAC frame 430 including an application data or network management information. The MAC payload 438 section includes payload information elements (IEs) 442 and frame payload 439. Payload information elements (IEs) 442 are variable-length fields containing additional information relevant to the MAC payload 438. The IEs 442 may carry higher-layer data or network management data required by the recipient for further processing or decision-making. For instance, the IEs 442 may contain routing information, network configuration parameters, or other types of application-specific data. Frame payload 439 is the actual payload of the MAC frame 430. Frame payload 439 holds data being transmitted between devices in the network. Depending on the frame type (e.g., data frame, acknowledgment frame, etc.), the frame payload 439 may vary in size and content. The frame payload 439 may contain application-level data, such as sensor readings, control messages, or other types of network communication.

The MAC footer 440 contains the frame check sequence (FCS) 441, which is used for error detection and data integrity during transmission. The FCS 441 is a 2- or 4-octet field containing a cyclic redundancy check (CRC). The FCS 440 helps the receiver detect errors which have occurred during transmission. In IEEE 802.15.4, the FCS 441 may be either 2 or 4 octets in length, depending on the PHY being used 2-octet FCS for standard IEEE 802.15.4 PHYs. 4-octet FCS is an extended version used when a device complies with specific PHYs, such as smart utility network (SUN) PHYs, as indicated in the SUN PHY capabilities information element (IE), or television white space (TVWS) PHYs, as indicated in the TVWS PHY operating mode description IE. The extended PHYs require the 4-octet CRC for robust error detection.

FIG. 4C shows a MAC command frame format 450, wherein MAC association request and response frames are command frames for IEEE 802.15.4 networks, according to some embodiments. The format of IEEE 802.15.4 MAC command frame 450, includes a MAC header (MHR) 435, a MAC payload 439, and a MAC footer (MFR) 442. The MAC command frame 450 supports network control and management operations, such as device association, disassociation, data polling, and network maintenance tasks.

The MAC header (MHR) 435 contains information for processing and routing the MAC command frame 450 across the network. The MAC header 435 includes a frame control field 432, a sequence number field 433, addressing fields 434, an auxiliary security header 436 and header information elements (IEs). The frame control field 432 is a 2-octet field defining operational parameters of the MAC command frame 450. The parameters include the type of MAC frame, such as a command frame, data frame, or acknowledgment frame, along with addressing mode, security settings, and protocol version. The frame control field 432 ensures the devices interpret and handle the MAC command frame 450 correctly. The sequence number field 433, with a length of 0 or 1 octet depending on the configuration, and is used to assign a unique sequence number to the MAC command frame 450. Th sequence number helps track frames, detect duplicates, and maintain the logical order of transmissions. The addressing fields 434 have variable lengths depending on addressing mode. The addressing fields 434 contain the source and destination PAN IDs and addresses, which guide the MAC command frame 450 to its intended recipient. The addresses range from 0 to 2 or 8 octets, depending on network requirements.

For networks with security enabled, the auxiliary security header 436 is included to provide information such as security keys, security level indicators, and cryptographic parameters. The auxiliary security header 436 helps ensure only authorized devices access or modify the transmitted data. The header information elements (IEs) field 437 may also be present, allowing the inclusion of optional metadata such as PHY layer settings, network performance metrics, or proprietary information for specific applications. The MAC payload 439 carries the core command message along with any supplementary information needed for executing the command. The payload information elements (IEs) may contain control parameters or network-specific data to assist with command execution.

The command ID field 440, is present as a single octet, identifies the type of command being transmitted. The command ID field 440 specifies whether the MAC command frame 450 pertains to an association request (0x01), an association response (0x02), a disassociation notification (0x03), a data request (0x04), a PAN ID conflict notification (0x09), or a beacon request (0x07). When a device wants to join the network, the device sends a MAC command frame 450 with an association request command ID. If the device wants to leave the network, the device uses the disassociation notification command ID. Alongside the command ID, the command content field carries the specific parameters associated with the command. The content varies depending on the command type; for example, an association request may include information about the device's capabilities, while a PAN ID conflict notification may carry the conflicting PAN ID.

The MAC footer (MFR) 442 ensures the integrity and accuracy of the transmitted data. The frame check sequence (FCS) 443, spanning either 2 or 4 octets, performs the function by using a cyclic redundancy check (CRC). The CRC algorithm computes a checksum based on the frame's content, which the receiver uses to detect any transmission errors. The selection of a 2-octet or 4-octet FCS depends on the network's physical layer. Networks utilizing smart utility network (SUN) PHYs or television white space (TVWS) PHYs often use 4-octet FCS for error detection capabilities. The IEEE 802.15.4 MAC command frame format 450 is structured to optimize communication, enhance security, and provide flexibility for various network operations. The MHR 435 provides frame identification, addressing, and security. The MAC payload 439 conveys specific command and its associated parameters. The MFR 442 guarantees the integrity of the transmitted data.

FIG. 4D shows a frame control field format 470 of IEEE 802.15.4 networks, according to some embodiments. FIG. 4D illustrates the format of the Frame Control field 470 used in the MAC command frame 450. The frame control field 470 has a length of two octets containing subfields defining the characteristics of the frame control field 470. The frame control field 470 includes is a 3-bit frame type 472, a 1-bit security enabled 473, a 1-bit frame pending 474, a 1-bit acknowledgment request (AR) 475, a 1-bit PAN ID compression 476, a 1-bit reserved 477, a 1-bit sequence number suppression 478, a 1-bit IE present 479, a 2-bit destination addressing mode 480, a 2-bit frame version 481, and a 2-bit source addressing mode 482. The 3-bit frame type 472, indicates the type of MAC frame being transmitted, such as a beacon, data, acknowledgment, or command frame. The 1-bit security enabled field 473, which specifies whether security features are applied to the frame control field 470.

The frame pending field 474, also 1-bit in size, signals whether additional frames are waiting for transmission to the same destination device. The acknowledgment request (AR) field 475, consisting of 1 bit, determines if an acknowledgment frame is expected from the recipient upon successful delivery. The PAN ID Compression field 476, is a 1-bit subfield, controls whether the source and destination PAN IDs are compressed when they share the same identifier, reducing overhead.

The frame control field 470 further includes a 1-bit reserved field 477, which is currently unused but may be allocated for future use. The sequence number suppression field 478, set as 1 bit, indicates whether the sequence number is included in the MAC header. The IE present field 479, is a 1 bit, specifies if the frame control field 470 contains information elements (IEs), which are used for additional control information. The destination addressing mode field 480 is 2 bits long and indicates how the destination address is formatted. The destination addressing mode field 480 represents no address, a short address, or an extended address depending on the network requirements. The frame version field 481, with 2 bits, identifies the version of the IEEE 802.15.4 standard being used. Finally, the source addressing mode field 482, which is 2 bits, describes the format of the source address, similarly offering options for no address, a short address, or an extended address.

### Standard IEEE 802.15.4 MAC Association Request Command Frame Configuration

FIG. 5 shows a PAN ID compression field 500 values for IEEE 802.15.4 networks, according to some embodiments. FIG. 5 is explained with reference to one or more elements from FIGS. 4C and 4D. The IEEE 802.15.4 MAC association request command frame is used by a device to join a beacon-enabled pan by sending the MAC association request command frame to the PAN coordinator 101. The configuration of MAC association request command frame involves various fields, each with distinct settings and parameters that support the association process.

The 2-octet frame control field may be configured with specific values. The frame type (explained briefly in FIG. 4D) is set to 0b011, indicating a MAC command frame 450 (explained briefly in FIG. 4C). The security enabled bit may be set to 0 or 1 depending on security requirements of the network. The frame pending bit is set to 0, indicating no additional frames are waiting for transmission. The acknowledgment request (AR) bit is set to 1, which signals the requirement for an acknowledgment of the frame. For the PAN ID Compression, the destination PAN ID is present, and the destination address may be a short or extended address. The source PAN ID may or may not be present, depending on the device's previous association status, while the source address is configured as an extended address. Based on the settings, FIG. 5 illustrates the corresponding value of PAN ID compression 500. The reserved bit is set to 0. The sequence number suppression bit is set to 0, as the AR bit is 1, indicating the sequence number is required. The information element (IE) present bit is set to 0 if no IE field is present and 1 if IE field is present.

The destination addressing mode matches the addressing mode used in the beacon frame to which the association request command refers. The destination addressing mode is set to 0b10 for a short address, which uses 2 octets, or 0b11 for an extended address, which uses 8 octets. The frame version is set to 0b10, following the IEEE 802.15.4 standard. The source addressing mode is set to 0b11, indicating the use of an extended 8-octet address.

The sequence number field is present in the MAC Association Request Command Frame because the AR bit is set to 1, indicating an acknowledgment is required. The addressing fields include a 2-octet destination PAN ID, and a destination address which may be either 2 octets for a short address or 8 octets for an extended address, depending on the address of the beacon transmitter. The source PAN ID may be present if the device has previously associated with another PAN, while the source address is always present and is configured as an 8-octet extended address. The presence of the auxiliary security header field depends on the security enabled bit in the frame control field. If security enabled bit is set to 1, the auxiliary security header is included; otherwise, auxiliary security header is omitted. The information element (IE) field's presence is similarly determined by the IE present bit in the frame control field. The command ID for the MAC association request command frame is set to 0x01.

FIG. 6A demonstrates the content field 600 of IEEE 802.15.4 networks MAC association request command, according to some embodiments. The association request command content field 600, depicted in FIG. 6A, includes a single octet and contains the capability information field, 602. The octet includes a series of bits, each serving a distinct purpose in defining the device's capabilities and operational characteristics within the IEEE 802.15.4 network as explained in FIG. 6B.

FIG. 6B shows capability information field format 650 of the content field in IEEE 802.15.4 MAC association request command, according to some embodiments. The capability information field format 650 includes a reserved bit 652, a device type 653, a power source 654, a receive on when idle bit 655, an association type bit 656, a reserved bit 657, a security capability 658 and a allocate address 659. The first bit is a reserved bit, set to zero with no specific functionality assigned, but maintains consistency with the protocol's structure. The bit device type 653, indicates whether the device operates as a full-function device (FFD). If device type bit 653 is set to one, the device performs all IEEE 802.15.4 MAC functions, including network coordination if required. A value of zero identifies the device as a reduced-function device (RFD), which typically has limited capabilities and interacts mainly with its parent coordinator.

The power source bit 654 signals whether the device is powered by an alternating current (AC) mains supply. A power source bit 654 value of one indicates the device receives power from AC mains, while zero signifies the device operates on an alternative power source, such as a battery. The receiver on when idle bit 655 follows, and represents the device's receiver activity during idle periods. A value of one indicates the device keeps its receiver active continuously, enabling the device to respond immediately to incoming transmissions. Conversely, a value of zero means the device conserves energy by disabling the receiver when idle.

The association type bit 656 serves to influence the grouping behavior during the network joining process. When association type bit 656 set to one, the device requests a fast association, which is beneficial for applications where immediate network access is required, such as secure door access systems. A bit value of zero for association type bit 656 indicates the device has no preference for expedited joining and follow the standard process. There is another reserved bit 657, which is similarly set to zero. The security capability bit 658, which determines if the device supports cryptographic protection for MAC frames. A value of one for security capability bit 658 indicates the device handle secure transmissions by sending and receiving encrypted data, while a value of zero for security capability bit 658 denotes a lack of the capability to handle secure transmission.

The last bit in the capability information field is the allocate address bit 659. When set to one, the device requests the PAN coordinator to assign a short address during the association process. If allocate address bit 659 is zero, the device uses an existing address or relies on its extended address for communication. The frame check sequence (FCS) field, associated with the command content field, verifies the integrity of the transmitted data. This ensures any errors occurring during transmission are detected and managed according to the protocol's error-checking mechanisms. Through the bit-level configurations, the capability information field 650 communicates the device's capabilities, security settings, and network joining preferences to the PAN coordinator 101.

### Standard IEEE 802.15.4 MAC Association Response Command Frame Configuration

A PAN coordinator 101 responds to the association request from a device intending to join the beacon-enabled PAN managed by PAN coordinator 101 with MAC Association Response Command frame 700.

FIG. 7A demonstrates the content field of IEEE 802.15.4 MAC association response command, according to some embodiments. MAC association response command frame is sent by the PAN coordinator 101 in response to an association request from a device which intends to join a beacon-enabled PAN. The relationship lies in the association response command content field 700, which is three octets long. The association response command content field 700 includes a 2-octet short address field 702 and a 1-octet association status field 703. The short address 702 field assigns a unique identifier to the requesting device for communication within the PAN, while the association status 703 field indicates the outcome of the association request. FIG. 7B provides a detailed breakdown of possible values for the association status field, defining whether the device has successfully associated, if the PAN is at capacity, if access is denied, or if there are other network constraints such as hopping sequence offset duplication.

FIG. 7B shows valid values of association status field 750 in the content field of IEEE 802.15.4 MAC association response command, according to some embodiments. When a device sends an association request, the PAN coordinator 101 constructs the MAC association response command frame based on the specified configuration parameters. The frame control field is set with a frame type value of 0b011, indicating a command frame. The security enabled bit may be either 0 or 1, depending on whether security features are active. The frame pending bit remains 0, while the acknowledgment request (AR) bit is set to 1, signaling an acknowledgment is required. The PAN ID compression setting indicates whether the destination PAN ID is present or omitted based on the addressing mode. In this configuration, the destination address is an extended address, while the source address is also an extended address with the source PAN ID field present.

The sequence number field is included, as the AR bit is set to 1, ensuring acknowledgment is expected. The addressing fields section contains the destination PAN ID, destination address, and source address. The auxiliary security header field is present only if the security enabled bit is set to 1. Additionally, the presence of the information elements (IE) field is dictated by the IE Present bit. The association response command content field, depicted in FIG. 7A, includes a short address field, which provides the device with a short address assigned by the PAN coordinator.

FIG. 7A further includes an association status field, which conveys the outcome of the association request. The possible values for the field include 0x00 for association successful 0x01 for PAN at capacity, indicating no more devices can join. 0x02 for PAN access denied, likely due to security settings or policy restrictions. 0x03 for hopping sequence offset duplication, which suggests a network configuration issue. 0x08 for fast association successful, indicating expedited network joining other values within the specified ranges are reserved for future use. The frame check sequence (FCS) field, which follows the content field, performs error detection for the frame's integrity.

### Modification of IEEE 802.15.4 MAC Association Response Command Frame for Group Association

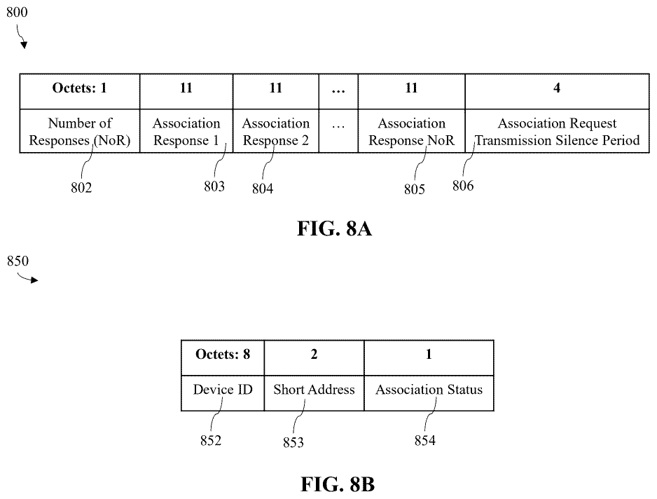

FIG. 8A demonstrates the group content field 800 for IEEE 802.15.4 MAC association response command with group response capability, according to some embodiments.

The modification of the IEEE 802.15.4 MAC association response command frame introduces a group association method to accelerate the association process within the network. The approach shifts from the conventional device-by-device association to a group-based association, where the PAN coordinator 101 communicates with multiple devices using a single response frame. The streamlined communication reduces network overhead and enhances efficiency, especially in scenarios involving a large number of devices. In the group association response command 800 method, the PAN coordinator 101 aggregates responses for multiple devices and transmits the responses in one frame rather than sending individual frames to each device. The changes to the MAC association response command frame include adjustments to both the frame control field and the content field to accommodate the method.

The acknowledgment request (AR) bit in the frame control field is set to 0. The change indicates immediate acknowledgments are not required, eliminating the need for each device to respond individually and reducing network traffic. The destination addressing mode in the frame control field is altered from 0b11 to 0b10. The change replaces the 8-octet extended address with a 2-octet short address, simplifying addressing for group communications. Additionally, the destination address field is modified from an extended address to the broadcast address 0xffff, allowing the frame to be received by all devices within the targeted group.

The content field, which is expanded from a fixed three-octet structure to a variable-length group content field, includes several components that enable efficient group-based association. The Number of Responses (NoR) field 802, which is one octet in length, specifies the total number of individual association responses contained within the frame. Each association response (association response 1 803, association response 2 804 and so on up to association response NoR) 805 includes 11 octets and includes details such as extended device ID, short address, and association status, allowing devices to recognize their assigned addresses and status within the network. The total number of association responses varies depending on the number of devices being associated in a given transmission. Each association response, is explained detailly in FIG. 8B.

The final element in the group content field is the association request transmission silence period 806. The association request transmission silence period 806 directs devices that have received an association response from the PAN coordinator 101 to temporarily pause the transmission of further association requests for a predefined duration, defined by the parameter macMinAssocReqTxTime. The controlled suspension period manages network contention by preventing excessive retransmissions and reducing the likelihood of collisions in the shared communication channel. By aggregating responses into a single frame, the group association method enhances the efficiency of the association process, minimizes transmission overhead, conserves network resources, and provides a scalable solution for larger networks with numerous devices seeking to join the PAN simultaneously.

FIG. 8B shows the format of each individual association response 850 in the group content field 800 for IEEE 802.15.4 MAC association response command with group response capability, according to some embodiments. FIG. 8B illustrates each association response 850 which contains three fields a device ID field 852, a short address field 853, and an association status field 854. The device ID field spans 8 octets and represents an extended address of the device requesting association. The extended address serves as a unique identifier within the network, allowing the PAN coordinator 101 to distinguish individual devices, even when multiple devices request association simultaneously.

The short address field is 2 octets long and contains a short address allocated to the device by the PAN coordinator 101 in the successful association. The short address is used for efficient communication within the network, as it reduces overhead compared to extended addresses. If the device has requested the PAN coordinator 101 to allocate the short address, the PAN coordinator 101 assigns one based on network addressing rules. The association status field is 1 octet and indicates the outcome of the association request. The possible values are shown in FIG. 7B and include statuses such as 0x00 for a successful association, 0x01 if the PAN is at capacity, 0x02 if the PAN access is denied, 0x03 for hopping sequence offset duplication, and 0x08 for fast association success. Reserved values are set aside for future extensions or vendor-specific implementations.

In addition, a retry count field can be defined to indicate the number of retransmissions allowed for devices in case of failed association attempts and an energy efficiency field can be defined to configure the association process to minimize power consumption for battery-operated devices.

### Interpretation of IEEE 802.15.4 MAC Association Response Command Frame for Group Association

When a candidate device 130 has requested for association receives an association response frame from corresponding PAN coordinator 101 as indicated by frame type in frame control field, checks if AR in frame control field is 1. If yes, the association response frame is a standard association response frame. If no, i.e., AR=0, the device checks if destination addressing mode in frame control field is 0b10. If no, the association response frame is an invalid frame. If yes, the device further checks if destination address in addressing fields is 2-octet short broadcast address 0xffff. If no, the association response frame is an invalid frame. If yes, the frame is a group association response frame. The device checks if its extended address is contained in the list of group responses. If yes, the device receives association response addressed to it. If no, the device waits for the next association response frame.

A device that receives an association response frame with group response capability does not transmit the immediate ACK since AR=0. Instead, the device transmits a delayed ACK in CAP period using CSMA/CA mechanism to let the PAN coordinator 101 know that the device received association response.

To limit the number of association responses contained in a group content field, a macMaxAssocNoR threshold may be defined. Multiple factors may be considered to define the threshold, e.g., the length of association response frame must not exceed the maximum MAC frame length.

### Devices Grouping for Group Association

In the large-scale device deployment, an IEEE 802.15.4 PAN coordinator 101 may group devices which have requested for association into groups for group association. Instead of sending individual association response to individual device like standard IEEE 802.5.4 association does, the PAN coordinator broadcast/multicast an aggregated association response frame that contains association responses to a group of devices. The PAN coordinator 101 associates the devices group by group. In addition, to reduce the probability of association request/response frame collision via CSMA/CA channel access mechanism, the candidate devices 130 that have sent association requests and received ACK from the PAN coordinator 101, do not send another association request to the same PAN coordinator 101 within a predefined macMinAssocReqTxTime period since it takes time for PAN coordinator 101 to process requests. The time period defined by macMinAssocReqTxTime is called silent period.

IEEE 802.15.4 PAN coordinator groups the devices in different ways including (1) association type-based grouping, (2) time-based grouping, (3) distance-based grouping, (4) communication channel-based grouping, and (5) Beamforming-based grouping.

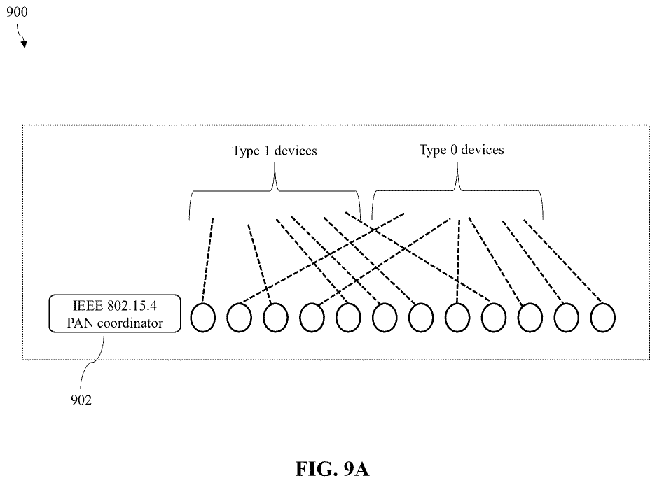

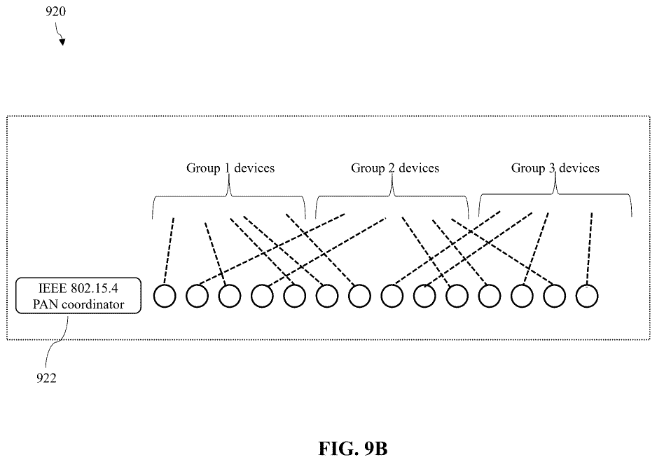

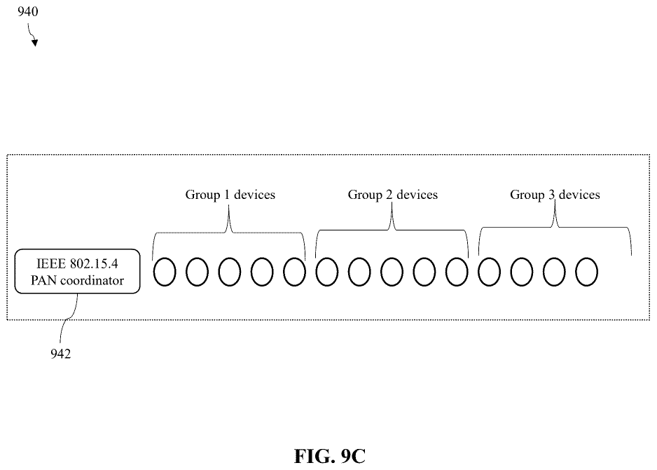

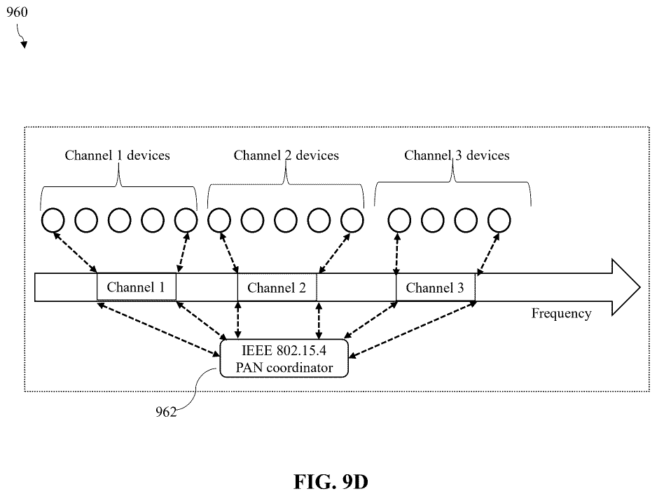

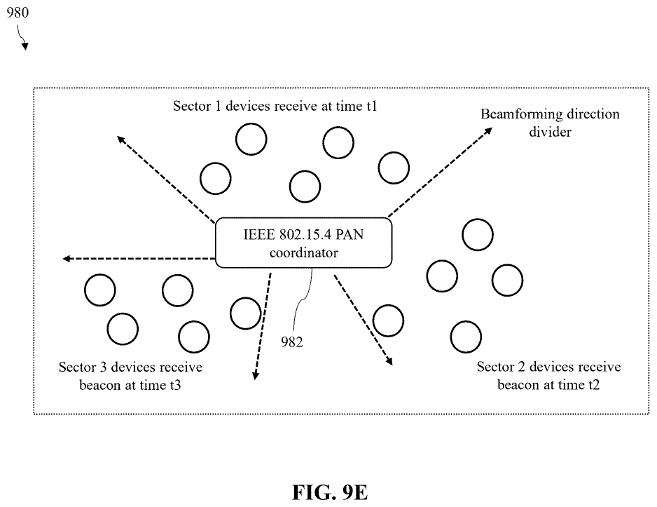

FIG. 9A shows association type-based device grouping method for group association in IEEE 802.15.4 standard, according to some embodiments. In association type-based device grouping, IEEE 802.15.4 PAN coordinator 902 divides the candidate devices that have requested for association into groups based on the association type contained in association request frame with type 1 requests into earlier response groups and type 0 requests into later response groups. FIG. 9A illustrates an example of association type-based grouping 900, in which the PAN coordinator 902 divides 12 candidate devices into two groups based on association type, wherein the association requests of type 1 devices are processed earlier than the requests of the type 0 devices.

For example, in a smart building deployment, there are different sensors installed, such as security sensors and temperature sensors, where security sensors have higher priority than temperature sensors do, thus security sensors request fast association, i.e., type 1 association, and temperature sensors request regular association, i.e., type 0 association.

FIG. 9B shows time-based device grouping method for group association in IEEE 802.15.4 standard, according to some embodiments. FIG. 9B illustrates an example of time-based grouping 920 consisting a PAN coordinator 922. The PAN coordinator 922 organizes candidate devices into groups based on the time their association requests are received. In large-scale deployments, where numerous devices seek network access, the time-based grouping method provides streamline association process by aggregating devices into time-based groups.

In various embodiments the PAN coordinator 922 monitors the incoming association requests and sorts devices into distinct groups according to when their requests arrive. The devices which have sent their requests earlier are placed into the initial groups, while later sent requests are assigned to subsequent groups. As illustrates in FIG. 9B, the PAN coordinator 922 has divided the 15 candidate devices into three groups: Group 1, Group 2, and Group 3. Each group contains a set of devices that transmitted their requests within similar time frames. Various embodiments include the devices that sent their requests earlier are placed into group 1, while devices whose requests transmitted slightly later are categorized into group 2, and devices with the latest request transmissions are assigned to group 3.

The PAN coordinator 101 uses the time-based grouping to send a single broadcast or multicast frame containing responses for all devices in a group, instead of responding individually to each device. The time-based grouping method reduces communication overhead and improves network efficiency. The devices in each group receive the aggregated response, which includes their assigned short addresses and association status information.

For example, consider a smart lighting system in a large office building. The building has hundreds of smart light bulbs, each equipped with IEEE 802.15.4 communication capability. When the light bulbs are powered on for the first time, the light bulbs need to associate with the central PAN coordinator to join the network. The PAN coordinator receives association requests from the light bulbs as the power on. Since different floors of the building may be powered on at different times, the coordinator groups the devices based on when their requests arrive. For instance, group 1 includes light bulbs on the first floor send requests first and get grouped together, group 2 includes a few minutes later, the second floor's bulbs send the requests and form the next group, group 3 include the third-floor bulbs send requests last and are placed in the final group. Adding a note, the PAN coordinator may form multiple groups according to the number of requests received from the devices. The PAN coordinator broadcasts one aggregated association response for each group. So, instead of individually acknowledging every bulb, the PAN coordinator sends a single response for all bulbs in the first-floor group, then another for the second-floor group, and so on.

FIG. 9C illustrates distance-based device grouping method for group association in IEEE 802.15.4 standard, according to some embodiments. FIG. 9C illustrates an example of distance-based grouping 940 consisting a PAN coordinator 942. The PAN coordinator 942 divides 15 candidate devices into three groups based on distance. Distance-based device grouping involves organizing devices based on the physical proximity to the PAN coordinator 942. The IEEE 802.15.4 PAN coordinator 942 measures the distance using techniques such as signal strength, time-of-flight measurements, or geometric positioning. The devices closer to the PAN coordinator are grouped to receive responses earlier, while those farther away form subsequent groups.

FIG. 9C, describes group 1 contains devices closest to the PAN coordinator 942, which are the first to communicate due to stronger signals and shorter transmission delays. Group 2 includes devices positioned at a moderate distance, and group 3 includes devices located farthest away, which experience weaker signals and longer delays. The distance-based grouping method of grouping improves communication efficiency by reducing signal collisions and transmission latency. The PAN coordinator 942 broadcasts the association responses in the groups, allowing devices to join the network based on their distance.

For example, consider a smart irrigation system deployed across a large agricultural field. The central control unit acts as the PAN coordinator and groups soil moisture sensors based on the distance. Sensors near the PAN coordinator, located around the main water pump, form group 1 and receive commands first to adjust watering schedules accurately. Sensors located in the middle of the field form group 2 and are addressed next to monitor soil conditions across larger sections. Finally, sensors at the far edges of the field form group 3 and receive responses last, ensuring the network manages communication resources efficiently without overwhelming the system. The distance-based grouping optimizes the network's performance by prioritizing reliable, low-latency communication with closer devices before handling those farther away.

There are also cases such as office door entry authentication where group 1 devices move away once they get associated with the PAN coordinator 942 so that group 2 devices move closer to the PAN coordinator for stronger signals and more efficient communications. Similarly, once group 2 devices get associated, group 3 devices move closer to the PAN coordinator.

FIG. 9D illustrates communication channel-based device grouping method for group association in IEEE 802.15.4 standard, according to some embodiments. In communication channel-based device grouping 960, the IEEE 802.15.4 PAN coordinator 962 organizes devices into groups depending on the communication channels over which the devices' association requests are received. To implement the communication channel-based grouping, the PAN coordinator 962 broadcasts beacon frames across multiple channels. When the candidate devices intend to join the network, the devices primarily initiate a network scanning process, which involves listening for the beacon frames. As the beacon frames are transmitted on different channels, devices naturally respond on the channels where they detect the beacon frames.

The behavior allows the PAN coordinator 962 to classify devices into distinct groups according to the communication channels the devices use. The PAN coordinator 962 transmits association response frames to each group on the corresponding channel. If the PAN coordinator 962 has multiple antennas, it may simultaneously send the responses on different channels, which significantly decreases network congestion. The distribution of devices across multiple channels reduces the likelihood of frame collisions and minimizes the overall time required for the association process.

FIG. 9D illustrates an example of communication channel-based grouping 960, showing how an IEEE 802.15.4 PAN coordinator 962 organizes candidate devices based on the channels they use for communication. Instead of processing all device association requests over a single channel, the PAN coordinator 962 distributes the devices across multiple communication channels, reducing contention and improving network efficiency. The PAN coordinator 962 assigns devices to three different groups, each corresponding to a distinct communication channel. The devices in group 1 operate on channel 1, devices in group 2 communicate over channel 2, and devices in group 3 use channel 3.

For example, in an industrial IoT (Internet of Things) deployment, sensors monitoring different parameters, such as temperature, humidity, and air quality, may need to communicate with a central controller. If all sensors attempt to associate on a single channel, congestion leads to delays and packet loss. By implementing channel-based grouping, the network may assign temperature sensors to channel 1, humidity sensors to channel 2, and air quality sensors to channel 3. The communication-based grouping method optimizes communication by allowing parallel data transmissions across multiple channels, ensuring a smoother and more responsive network.

FIG. 9E depicts beamforming-based grouping 980 method for group association in IEEE 802.15.4 standard, according to some embodiments. FIG. 9E includes a PAN coordinator 982 and plurality of devices which are sending association requests to join the network. In beamforming-based device grouping 980, the IEEE 802.15.4 PAN coordinator 982 organizes devices based on the directional sectors relative to the PAN coordinator 982. The PAN coordinator 982 transmits beacon frames in different directional sectors at different times, allowing devices located in specific directions to receive the beacon at distinct time intervals. For example, if the PAN coordinator 982 defines sectors with a 90-degree granularity, plurality of devices may be divided into four directional sectors. The candidate devices intending to join the network within different sectors detect beacons at different times, leading to the classification based on relative location.

The PAN coordinator 982 processes association requests sector by sector/multiple sectors. Within each sector, the PAN coordinator 982 may implement either a standard association mechanism or a group association mechanism. The beamforming-based grouping method reduces the probability of frame collisions between association requests and responses since fewer devices compete for the channel in each sector. Additionally, if the PAN coordinator 982 has the capability to transmit in multiple sectors simultaneously, it may send association responses to multiple groups at once, reducing overall association latency.

FIG. 9E presents an example of beamforming-based grouping 980, where all devices compete simultaneously to communicate with the PAN coordinator 982, beamforming-based grouping introduces a structured approach by segmenting devices based on the relative direction. The PAN coordinator 982 transmits beacon frames sequentially in different sectors, allowing devices located in specific regions to receive the beacon at different time instances.

In FIG. 9E, the PAN coordinator 982 divides 15 devices into three distinct groups, each corresponding to a particular beamforming sector. Devices in sector 1 receive the beacon first, at time t1, and subsequently send their association requests to the PAN coordinator 982. Devices in sector 2 receive the beacon at time t2, initiating their association process afterward. Similarly, devices in sector 3 receive the beacon at time t3, completing the final group in this association cycle. Since devices within the same sector detect the beacon at the same time, the devices form a single group and proceed with the association process together.

For example, in a smart agriculture deployment, sensors distributed across a large field may be located in different directional sectors relative to the central base station. The base station uses beamforming to send beacons toward different sections of the field at separate times. As a result, sensors in each sector receive the beacon at different times and send association requests accordingly.

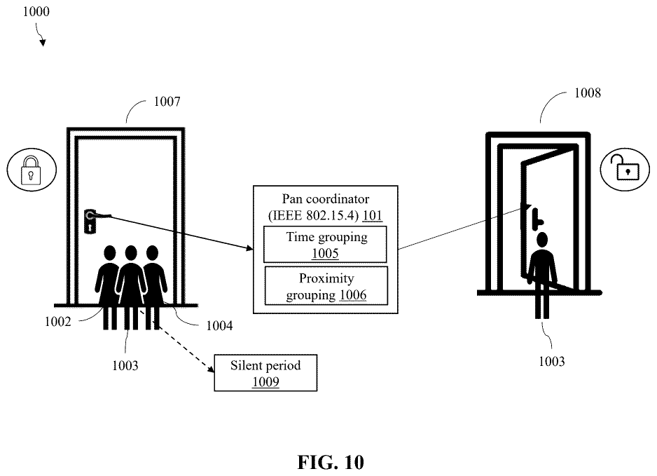

FIG. 10 depicts a flow diagram illustrating a use case for group association for IEEE 802.15.4 networks, according to some embodiments. FIG. 10 presents a door authentication system 1000 where devices associate based on time or proximity. The system 1000 controls access of a locked door 1007 by managing the authentication of key tags carried by individuals. The PAN coordinator 101 plays a central role in processing key tag authentication requests efficiently by grouping them based on time grouping 1005 or proximity grouping 1006.

FIG. 10 includes three individuals 1002, 1004, and 1003 approach the locked door 1007, each carrying a key tag which transmits an association request to the PAN coordinator 101. Instead of handling each request independently, the PAN coordinator 101 groups key tags based on either the time their requests were received or their relative proximity to each other.

In a time-based grouping scenario, if 1002 and 1004 send authentication requests within a short time window, the PAN coordinator 101 processes the key tags together, regardless of their physical positions. In proximity-based grouping, if 1002 and 1004 are physically close to each other when requesting access, they are grouped as a batch, even if other users sent requests earlier. When the group is formed, the PAN coordinator 101 verifies the key tags in the batch and grants access by unlocking the door 1007, which transitions to its unlocked state 1008. Individuals 1002 and 1004 proceed through the door while 1003, whose key tag was not part of the first group, enters a silent period 1009. During the silent period 1009, 1003's key tag temporarily stops sending repeated authentication requests, preventing unnecessary transmission congestion. The approach minimizes delays and optimizes resource utilization by allowing the system to process access requests in an organized manner.

After 1002 and 1004 have passed through the door 1008, the PAN coordinator 101 reevaluates pending authentication requests. At the point, 1003's key tag, which was in silent mode, is reactivated and processed for authentication. Once verified, the locked door 1007 unlocks again, transitioning to its unlocked state 1008, allowing 1003 to enter.

The group-based authentication mechanism is particularly useful in high-traffic environments such as office buildings, data centers, and secured facilities, where multiple individuals often need access at the same time. The system 100 may also incorporate additional refinements, such as dynamic group size adjustments based on real-time traffic patterns or user priority levels. For instance, higher-priority personnel may be granted immediate access even if they arrive outside the grouping window, while regular users are grouped to optimize efficiency.

Additionally, the PAN coordinator may utilize adaptive silent period adjustments based on previous network conditions. If frequent collisions or delays are detected, the silent period may be extended dynamically to optimize system performance. Furthermore, in environments where proximity-based grouping is preferred, advanced techniques such as signal strength estimation, Bluetooth Low Energy (BLE) beacons, or ultra-wideband (UWB) positioning may be integrated to accuracy in grouping individuals based on their location.

Additionally, the network coordinator may dynamically adjust the grouping criteria based on various network conditions to improve communication efficiency. The PAN coordinator may consider factors such as network traffic load, which reflects the current congestion level on each communication channel, and device density, representing the number of devices attempting to associate within a given time window. By analyzing these parameters, the PAN coordinator may modify the grouping strategy to balance the network load, minimize collisions, and enhance overall performance. Additionally, other network information, such as signal interference levels, transmission delays, and power constraints, may influence how devices are grouped for association, allowing the network to adapt to changing conditions in real time.

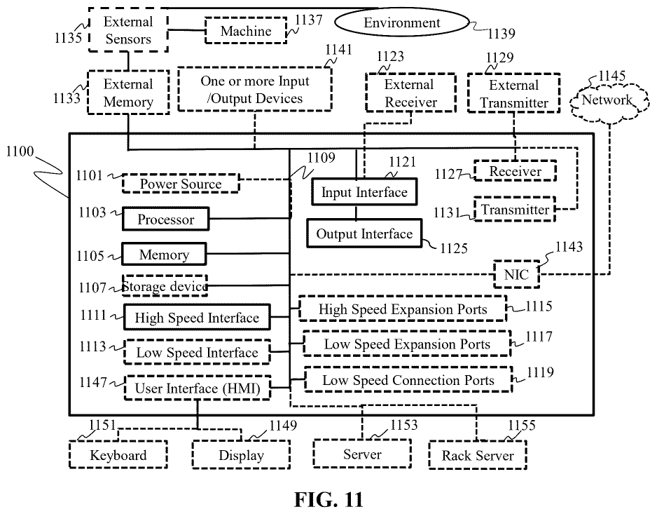

FIG. 11 shows a schematic diagram of some components of a system 1100 for group association for IEEE 802.15.4 networks, in accordance with some embodiments of the present disclosure. The system 1100 includes a power source 1101, a processor 1103, a memory 1105, a storage device 1107, all connected to a bus 1109. Further, a high-speed interface 1111, a low-speed interface 1113, high-speed expansion ports 1115 and low speed connection ports 1117, can be connected to the bus 1109. In addition, a low-speed expansion port 1119 is in connection with the bus 1109. Further, an input interface 1121 can be connected via the bus 1109 to an external receiver 1123 and an output interface 1125. A receiver 1127 can be connected to an external transmitter 1129 and a transmitter 1131 via the bus 1109. Also connected to the bus 1109 can be an external memory 1133, external sensors 1135, machine(s) 1137, and an environment 1139. Further, one or more external input/output devices 1141 can be connected to the bus 1109. A network interface controller (NIC) 1143 can be adapted to connect through the bus 1109 to a network 1145, wherein data or other data, among other things, can be rendered on a third-party display device, third party imaging device, and/or third-party printing device outside of the system 1100.

The memory 1105 may store instructions that are executable by the system 1100 and any data that can be utilized by the methods and systems of the present disclosure. The memory 1105 can include random access memory (RAM), read only memory (ROM), flash memory, or any other suitable memory systems. The memory 1105 can be a volatile memory unit or units, and/or a non-volatile memory unit or units. The memory 1105 may also be another form of computer-readable medium, such as a magnetic or optical disk.

The storage device 1107 can be adapted to store supplementary data and/or software modules used by the system 1100. The storage device 1107 can include a hard drive, an optical drive, a thumb-drive, an array of drives, or any combinations thereof. Further, the storage device 1107 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 1103), perform one or more methods, such as those described above.

The system 1100 can be linked through the bus 1109, optionally, to a display interface or user Interface (HMI) 1147 adapted to connect the system 1100 to a display device 1149 and a keyboard 1151, wherein the display device 1149 can include a computer monitor, camera, television, projector, or mobile device, among others. In some implementations, the system 1100 may include a printer interface to connect to a printing device, wherein the printing device can include a liquid inkjet printer, solid ink printer, large-scale commercial printer, thermal printer, UV printer, or dye-sublimation printer, among others.

The high-speed interface 1111 manages bandwidth-intensive operations for the system 1100, while the low-speed interface 1113 manages lower bandwidth-intensive operations. Such allocation of functions is an example only. In some implementations, the high-speed interface 1111 can be coupled to the memory 1105, the user interface (HMI) 1145, and to the keyboard 1151 and the display 1149 (e.g., through a graphics processor or accelerator), and to the high-speed expansion ports 1115, which may accept various expansion cards via the bus 1109. In an implementation, the low-speed interface 1113 is coupled to the storage device 1107 and the low-speed expansion ports 1117, via the bus 1109. The low-speed expansion ports 1117, which may include various communication ports (e.g., USB, Bluetooth, Ethernet, wireless Ethernet) may be coupled to the one or more input/output devices 1141. The system 1100 may be connected to a server 1153 and a rack server 1155. The system 1100 may be implemented in several different forms. For example, the system 1100 may be implemented as part of the rack server 1155.

The above description provides exemplary embodiments only, and is not intended to limit the scope, applicability, or configuration of the disclosure. Rather, the above description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the above description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a FIG. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

1. A method for performing group-based association in a wireless communication network compliant with the IEEE 802.15.4 standard, the method comprising:
receiving, by a network coordinator, association requests from a plurality of devices seeking to join the network;
grouping the plurality of devices into one or more groups based on at least one grouping criterion selected from: (1) an association type indicating priority of devices seeking association, (2) a time interval during which the association requests were received, (3) spatial proximity of the devices to the network coordinator, (4) a communication channel used by the devices, or (5) a beamforming direction relative to the network coordinator;
transmitting, by the network coordinator, a group association response to each group, the association response including parameters required for devices within the group to complete the association process;
announcing, by the network coordinator, a silent period for devices outside an active group during transmission of the association response to reduce channel access contention and transmission collision; and
completing the association of the devices in each group with the network coordinator in a sequential or parallel manner.

2. The method of claim 1, wherein the association type used is determined by the devices based on application type of the plurality of devices, wherein high priority and time-critical applications are assigned higher priority for association.

3. The method of claim 1, wherein the time interval used as a grouping criterion is dynamically adjusted based on a density of association requests received by the network coordinator.

4. The method of claim 1, wherein the spatial proximity of devices is determined based on geometric locations between the devices and the network coordinator or signal strength or time-of-flight measurements between the devices and the network coordinator or other localization information.

5. The method of claim 1, wherein the communication channel used by the devices is determined during a network scanning phase in which the devices listen for beacon frames transmitted by the network coordinator on multiple channels.

6. The method of claim 1, wherein the beamforming direction is determined by dividing a coverage area of the network into sectors, with each sector corresponding to a distinct beamforming direction.

7. The method of claim 1, wherein the group association response includes unique identifiers for the plurality of devices in the group to confirm successful association or unsuccessful association.

8. The method of claim 1, further comprising:
instructing devices outside the active group to refrain from transmitting association requests during the silent period, thereby reducing contention during the association process.

9. The method of claim 1, wherein the network coordinator simultaneously transmits association responses to multiple groups using distinct communication channels.

10. The method of claim 1, further comprising:
dynamically updating the grouping criteria based on real-time network conditions, including the number of devices seeking association and the overall channel traffic.

11. The method of claim 1, wherein the group-based association process is integrated with existing security protocols to ensure that only authenticated devices are allowed to join the network.

12. The method of claim 1, wherein the group association response transmitted by the network coordinator includes:
a number of responses field specifying the number of devices responded by this group association response;
a plurality of association responses to devices in a group; and
an association request transmission silence period announcement field directing devices to refrain from transmitting association requests during the silent period.

13. The method of claim 1, wherein an association request frame transmitted by a device includes:
an extended device address field identifying a requesting device; and
an association type in Capacity Information field set to 1 to indicate a fast association request for high priority and time-critical network joining to influence grouping and set to 0 for low priority network joining.

14. The method of claim 1, wherein the group association response includes:
a silent period announcement field directing devices whose association request transmissions have been acknowledged by the network coordinator to suspend association request transmissions during group association, with values for a start time being a time group association response overheard and a duration specified by the silent period announcement field.

15. The method of claim 1, wherein the grouping criteria based on association type, time and distance are implemented using:
an association type indicating the priority of devices seeking association;
a time at which network coordinator receives the association request from a time; and
a distance between a device and network coordinator determined based on geometric locations between a device and network coordinator or estimated using signal strength or time-of-flight measurements between the devices and the network coordinator or other localization methods.

16. The method of claim 1, wherein the grouping criteria based on communication channel and beamforming are implemented using:
a communication channel on which association requests are received by network coordinator; and
a beamforming direction sector of a device with respect to network coordinator indicating a spatial sector corresponding to the beamforming transmission.

17. The method of claim 1, wherein the group association response contains a plurality of association responses to devices in a group, wherein each association response includes:
an extended device ID specifying a unique identifier of a device responded by network coordinator in group association response;
an assigned short address by the network coordinator to the device in the successful association; and
a group association status field providing feedback on the status of the device association process, with values of an Associated when the device is successfully associated, a Pending when the device association in progress; and rejected when the device association request is denied due to unmet criteria or network capacity.

18. The method of claim 1, wherein the network coordinator dynamically adjusts the grouping criteria based on:
a network traffic load field indicating current traffic on each channel; and
a device density field representing the number of devices attempting association within a given time window.

19. The method of claim 1, wherein the group association response transmitted using one of following methods:
Standard association response transmission;
sequential or simultaneous beamforming transmission to different direction sectors; and sequential or simultaneous transmission on multiple communication channels.

20. The method of claim 1, wherein the group association method incorporates collision management using:
a retry count field indicating the number of retransmissions allowed for devices in case of failed association attempts:
a collision resolution field providing instructions for retrying the association request.

21. The method of claim 1, wherein a protocol IEEE 802.15.4 standard supports large-scale applications by including:
a scalability indicator field denoting the maximum number of devices that can be associated within a single group; and
an energy efficiency field configuring the association process to minimize power consumption for battery-operated devices.
